(19) United States
(12) Patent Application Publication
(10) Pub. No.: US 2009/0029330 A1
(43) Pub. Date: Jan. 29, 2009

(54) Toddler Device

(76) Inventor: Brooke Moran, De Pere, WI (US)

Correspondence Address: HARSHAW RESEARCH, INC., 210 W. TECUMSEH STREET, OTTAWA, KS, 66067, US

(21) Appl. No.: 11/781,384

(22) Filed: Jul. 23, 2007

(51) Int. Cl. G09B 19/00

(52) U.S. Cl. 434/255; 446/227

(57) ABSTRACT

A toddler device according to the present invention includes a base having a generally planar upper surface and defining a plurality of receiving holes. Further, the toddler device includes a set of posts, each post having an upper end and a lower end with a configuration complementary to a configuration of at least one of the receiving holes. Each post is padded, may include a liquid resistant surface, and is supported in a vertical configuration when received in a respective receiving hole. In addition, an entertainment element is coupled to respective post upper ends for interesting a toddler and encouraging the toddler to stand.

### BACKGROUND OF THE INVENTION

This invention relates generally to toddler training devices and, more particularly, to a toddler device for use in training a toddler in his transition from crawling to walking. The toddler device is intended to entertain, motivate, and assist a toddler who is learning to walk.

Toddlers learning to stand and walk often pull themselves up to furniture such as a couch, chair, end table, or the like, and then take a few steps with the steadying influence of the furniture. Toddlers also enjoy playing on and around play stations such as those having steps and slides. Often, however, the toddler reverts to crawling if not sufficiently motivated or entertained.

Various devices have been proposed in the art for assisting toddlers with learning to walk, such as walkers and other push toys. Although assumably effective for their intended purposes, the existing devices do not provide assistance that surrounds a toddler while still challenging the toddler to stand, walk, and play with toys from the standing position.

Therefore, it would be desirable to have a toddler device having multiple upstanding pylons that encourage and assist a toddler in learning to stand. Further, it would be desirable to have a toddler device that includes playthings positioned along and atop the pylons for encouraging the toddler to stand while he plays.

### SUMMARY OF THE INVENTION

Accordingly, a toddler device according to the present invention includes a base having a generally planar upper surface and defining a plurality of receiving holes. Further, the toddler device includes a set of posts, each post having an upper end and a lower end with a configuration complementary to a configuration of at least one of the receiving holes. Each post is padded and is supported in a vertical configuration when received in a respective receiving hole. In addition, an entertainment element is coupled to respective post upper ends for interesting a toddler and encouraging the toddler to stand.

Therefore, a general object of this invention is to provide a toddler device for encouraging and assisting a toddler in learning to stand.

Another object of this invention is to provide a toddler device, as aforesaid, having multiple upstanding padded pylons that a toddler may grasp for stability while standing.

Still another object of this invention is to provide a toddler device, as aforesaid, having entertainment objects positioned along or atop selected pylons for encouraging a toddler to stand and play.

Yet another object of this invention is to provide a toddler device, as aforesaid, having a padded base for cushioning a toddler who may fall while standing or attempting to stand.

A further object of this invention is to provide a toddler device, as aforesaid, that is safe for toddlers, economical to manufacture, and user-friendly for an adult to manipulate.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a toddler device according to one embodiment of the present invention;

FIG. 2 is another perspective view of the toddler device as in FIG. 1 with the play things removed;

FIG. 3 is still another perspective view of the toddler device as in FIG. 1;

FIG. 4a is an isolated view on an enlarged scale of a plaything taken from a portion of FIG. 3;

FIG. 4b is another isolated view on an enlarged scale of a plaything taken from a portion of FIG. 3;

FIG. 4c is another isolated view on an enlarged scale of a plaything taken from a portion of FIG. 3;

FIG. 5a is another isolated view on an enlarged scale of a plaything taken from a portion of FIG. 3;

FIG. 5b is another isolated view on an enlarged scale of a plaything taken from a portion of FIG. 3;

FIG. 5c is another isolated view on an enlarged scale of a plaything taken from a portion of FIG. 3;

FIG. 6a is a perspective view of a toddler device according to another embodiment of the present invention;

FIG. 6b is an isolated view on an enlarged scale taken from a portion of FIG. 6a.

FIG. 7a is a perspective view of the toddler device as in FIG. 1 taken from another angle; and

FIG. 7b is an isolated view on an enlarged scale taken from a portion of FIG. 7a.

### DESCRIPTION OF THE PREFERRED EMBODIMENT

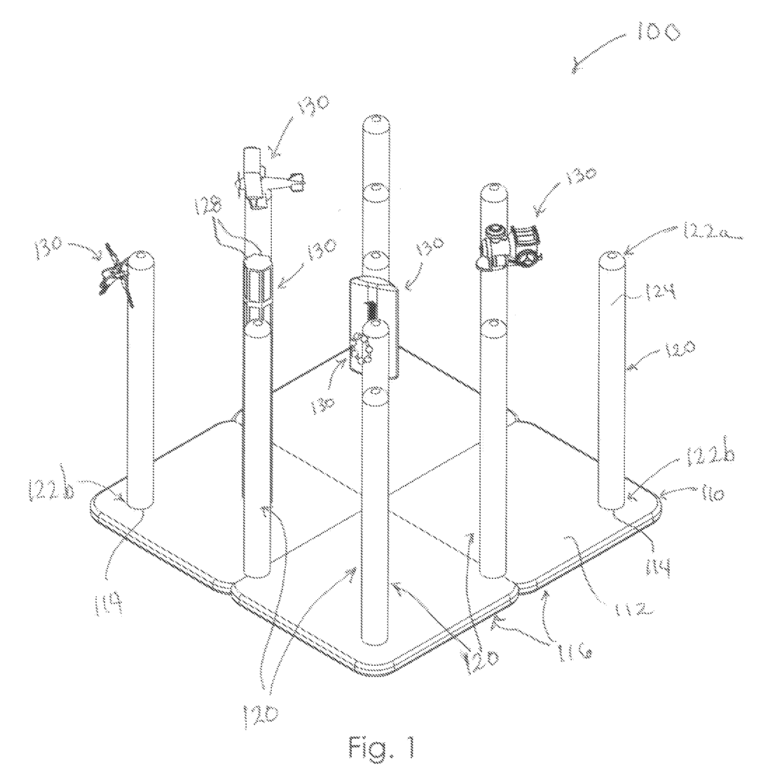

A toddler device 100 according to the present invention will now be described in detail with reference to FIGS. 1 through 6 of the accompanying drawings. More particularly, according to the current invention, a toddler device 100 includes a base 110, a set of posts 120, and at least one entertainment element 130.

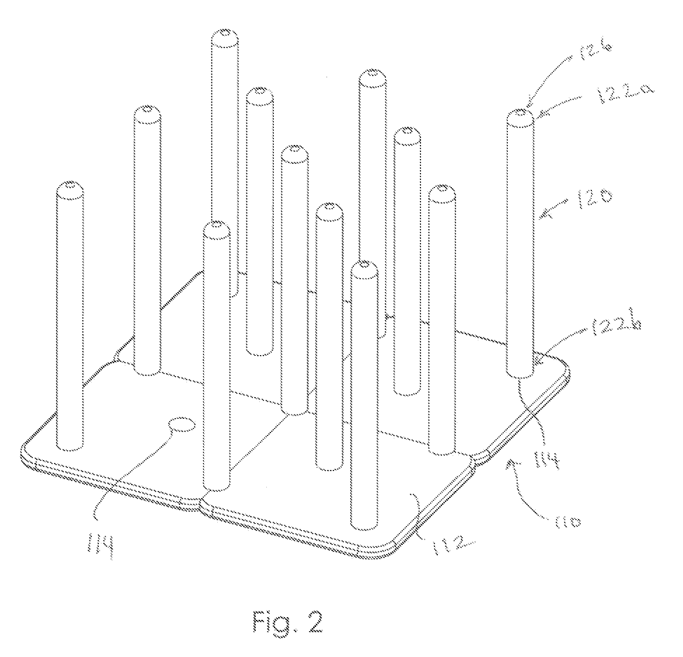

The base 110 has a generally planar upper surface 112 and defines a plurality of receiving holes 114 (FIG. 2). The base upper surface 112 may be padded and may include a liquid resistant material such as vinyl so that the base 110 can be easily cleaned. As shown in FIG. 1, a plurality of discrete floor sections 116 may collectively define the base 110, or the base 110 may alternately be of unitary construction. A base 110 of one embodiment is approximately four feet long by four feet wide, though other sizes could be used.

Each post 120 has an upper end 122a and a lower end 122b with a configuration complementary to a configuration of at least one receiving hole 114. As shown in FIGS. 1 and 2, this allows the posts 120 to be supported in a vertical configuration when received in a respective receiving hole 114. The lower ends 122b may be complementary to multiple receiving holes 114 (including all of the receiving holes 114) so that the posts 120 can be interchangeably coupled to the base, or a respective lower end 122b may alternately be complementary to only one receiving hole 114.

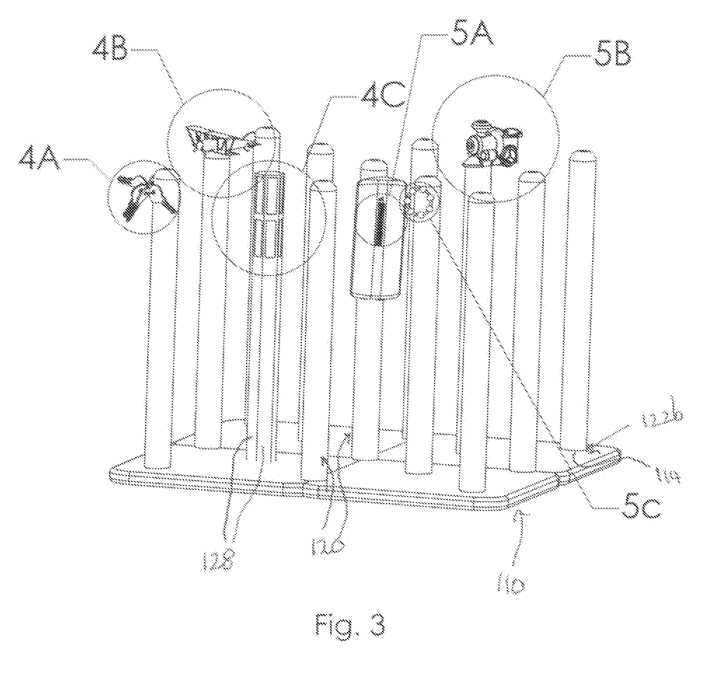

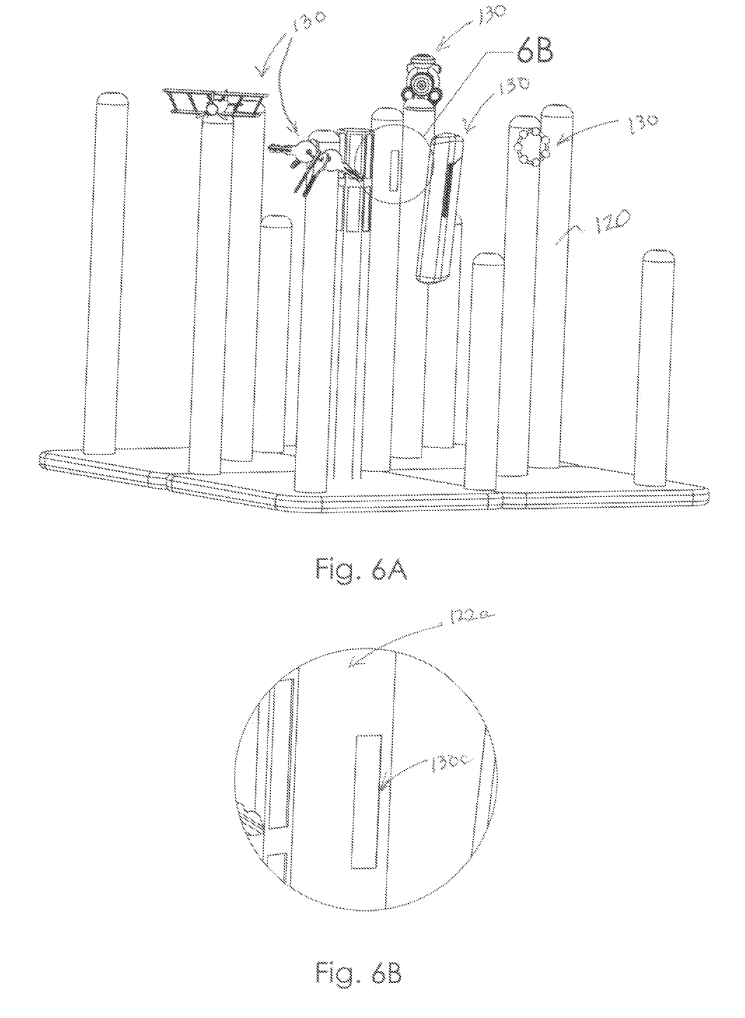

The posts 120 may have padded outer surfaces 124, and tactile properties may vary between different posts 120 and/or different portions of a single post 120. For example, one post 120 may have a smooth surface while another post 120 has a bumpy surface, or one post 120 may have a smooth portion and a bumpy portion. As shown in FIG. 1, all of the posts 120 may have the same height, or as shown in FIG. 6, the posts 120 may have different heights. Further, as shown in FIG. 2, all of the posts 120 may have cylindrical configurations 126, or as shown in FIGS. 1 and 3, posts 120 may have a plurality of generally planar sides 128.

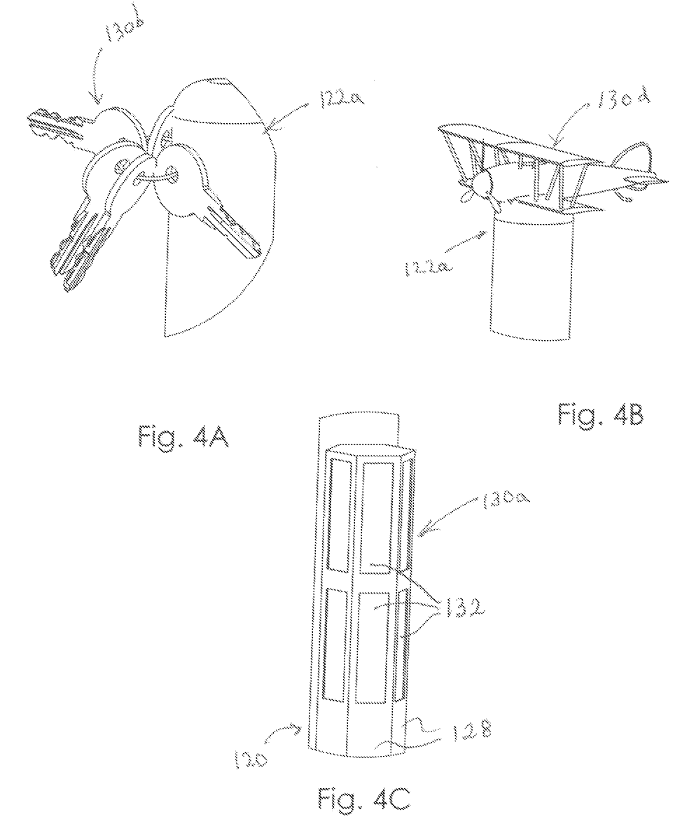

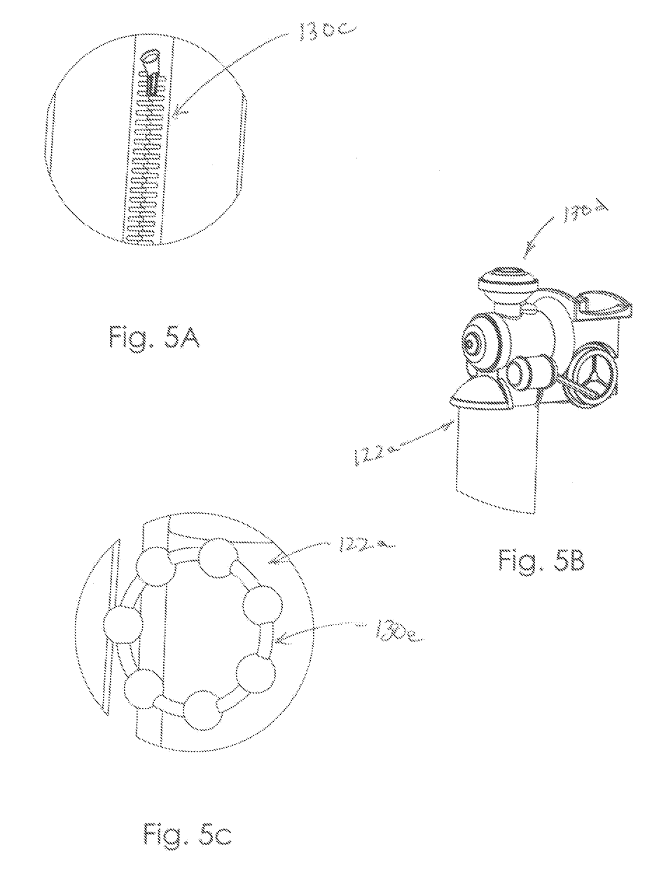

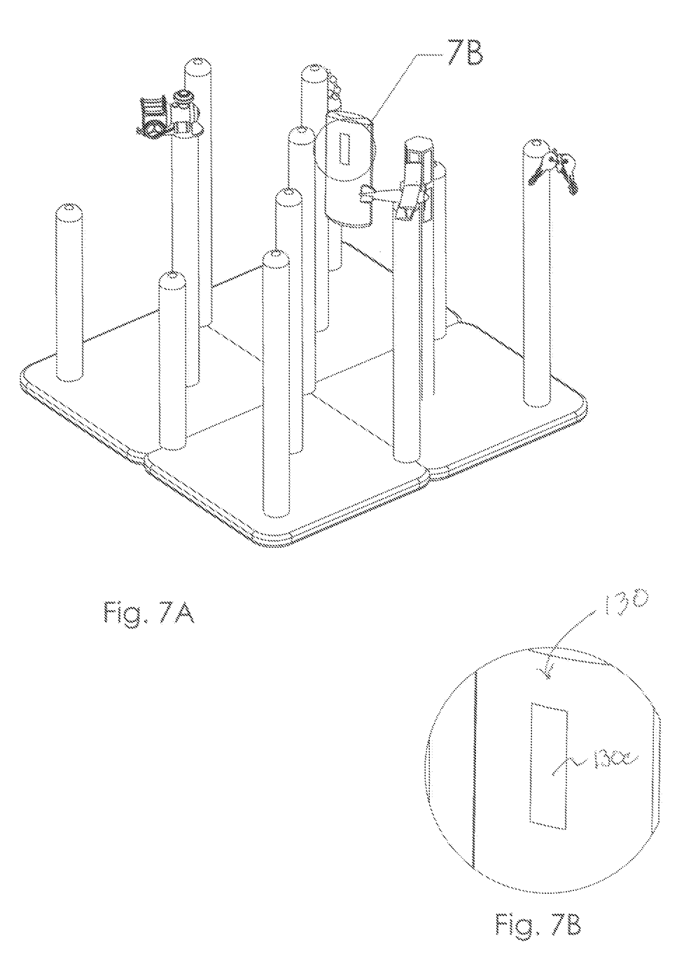

The entertainment element 130 is coupled to a respective post upper end 122a for interesting a toddler and encouraging the toddler to stand on the base 110. As shown throughout the drawings, a plurality of entertainment elements 130 may be coupled to respective post upper ends 122a, and the entertainment elements 130 may vary from one another. The entertainment elements 130 may be, for example, a mirror unit 130a, a noise-making device 130b (e.g., the keys shown in FIG. 4a, a rattler, an electronic noise-maker, etc.), a fastening device 130c (e.g., the zipper shown in FIG. 5a, snaps, buttons, magnets, hook and loop fasteners as shown in FIGS. 7a and 7b etc.), a vehicle 130d (e.g., the airplane shown in FIG. 4b or the train shown in FIG. 5b, an automobile, the teething ring 130e shown in FIG. 5c etc.), an animal, an electronic gadget, or another appropriate device. The mirror unit 130a shown in FIG. 4c has a plurality of mirrors 132 on different sides 128 of the post 120. It is understood that a fastening device 130c such as a hook and loop fastener may also be situated on a respective post 120 as shown in 6a and 6b.

In use, the base 110 may be placed on a flat surface with the upper surface 112 facing upwardly, and the lower ends 122b of the posts 120 may be received in the receiving holes 114 so that the posts 120 extend generally vertically as shown in FIGS. 1, 2, and 6. The entertainment elements 130 at the post upper ends 122a may interest a toddler and encourage the toddler to stand on the base 110 to interact with or explore the entertainment element 130. This may be especially useful in the toddler's development during the transition from crawling to standing and walking. Similarly, the different tactile characteristics of the posts 120 may encourage the toddler to stand.

To allow the toddler to walk on the base 110, the posts 120 may be spaced apart a sufficient distance, and the padded nature of the base 110 and the posts 120 may minimize danger to the toddler from falling on the base 110 or a post 120. The liquid resistant material of the base 110 may allow the base 110 to be easily cleaned. By having some posts 120 shorter than others (FIG. 6), the toddler may be able to reach additional entertainment elements 130 as the toddler grows, increasing the useful life of the device 100 to the toddler.

It is understood that while certain forms of this invention have been illustrated and described, it is not limited thereto except insofar as such limitations are included in the following claims and allowable functional equivalents thereof.

1. A toddler device, comprising:
a base having a generally planar upper surface and defining a plurality of receiving holes;
a set of posts, each post having an upper end and a lower end with a configuration complementary to a configuration of at least one said receiving hole, each post being supported in a vertical configuration when received in a respective receiving hole; and
an entertainment element coupled to a respective post upper end for interesting a toddler and encouraging the toddler to stand.

2. The toddler device as in claim 1, wherein said posts have padded outer surfaces.

3. The toddler device as in claim 1, wherein said base upper surface is padded and includes a liquid resistant material.

4. The toddler device as in claim 1, wherein:
a plurality of said post upper ends have entertainment elements; and
at least one said entertainment element is different from at least one other said entertainment element.

5. The toddler device as in claim 4, wherein:
said posts have padded outer surfaces; and
said base upper surface is padded and includes a liquid resistant material.

6. The toddler device as in claim 5, wherein:
at least one said post has a height that is different from a height of at least one other said post;
at least one said post has a surface with tactile properties that are different from tactile properties of at least one other said post; and
a plurality of discrete floor sections collectively define said base.

7. The toddler device as in claim 1, wherein at least one said post has a height that is different from a height of at least one other said post.

8. The toddler device as in claim 1, wherein said entertainment element is selected from a mirror, a noise-making device, a fastening device, and a vehicle.

9. The toddler device as in claim 1, wherein at least one said post has a surface with tactile properties that are different from tactile properties of at least one other said post.

10. The toddler device as in claim 1, wherein a plurality of discrete floor sections collectively define said base.

11. The toddler device as in claim 1, wherein:
said post has a plurality of sides; and
said entertainment element is a mirror unit having a plurality of mirrors, at least two said mirrors being on different said post sides.

12. A toddler device, comprising:
a base having a generally planar upper surface and defining a plurality of receiving holes;
a plurality of cylindrical posts having upper and lower ends, each lower end having a configuration complementary to a configuration of at least one said receiving hole for coupling said post to said base, each post being supported in a vertical configuration when coupled to said base; and
a plurality of entertainment elements, each respective entertainment element being coupled to a respective post upper end for interesting a toddler and encouraging the toddler to stand on said base.

13. The toddler device as in claim 12, wherein:
said posts have padded outer surfaces; and
said base upper surface is padded and includes a liquid resistant material.

14. The toddler device as in claim 12, wherein at least one said entertainment element is different from at least one other said entertainment element.

15. The toddler device as in claim 12, wherein:
at least one said post has a cylindrical configuration; and
at least another said post has a plurality of generally planar sides.

16. The toddler device as in claim 12, wherein each lower end has a configuration complementary to a configuration of each said receiving hole for interchangeably coupling said post to said base.

17. The toddler device as in claim 16, wherein:
at least one said entertainment element is different from at least one other said entertainment element;
said posts have padded outer surfaces; and
said base upper surface is padded and includes a liquid resistant material.

18. The toddler device as in claim 17, wherein:
at least one said post has a surface with tactile properties that are different from tactile properties of at least one other said post; and
at least one said post has a height that is different from a height of at least one other said post.

19. The toddler device as in claim 18, wherein said entertainment element is selected from a mirror, a noise-making device, a fastening device, and a vehicle.

20. The toddler device as in claim 16, wherein:
at least one said entertainment element is different from at least one other said entertainment element; and
said posts have padded outer surfaces.
